(19) United States
(12) Patent Application Publication
(10) Pub. No.: US 2005/0216713 A1
(43) Pub. Date: Sep. 29, 2005

(54) Instruction text controlled selectively stated branches for prediction via a branch target buffer

(75) Inventors: Brian Robert Prasky, Wappingers Falls, NY (US); Mark Anthony Check, Hopewell Junction, NY (US); Bruce Conrad Giamei, Poughkeepsie, NY (US); Timothy J. Slegel, Staatsburg, NY (US)

Correspondence Address: Richard M. Goldman, Suite 208, 371 Elan Village Lane, San Jose, CA, 95134, US

(73) Assignee: International Business Machines Corporation, Armonk, NY (US)

(21) Appl. No.: 10/809,749

(22) Filed: Mar. 25, 2004

(51) Int. Cl. G06F 9/00

(52) U.S. Cl. 712/238

(57) ABSTRACT

Disclosed is a method and apparatus providing the capability to prevent particular branches from being written into the BTB, thereby making them non-predictable. By making certain branches only detectable at decode time frame, branch prediction can completely run asynchronous of decode. By allowing branch prediction logic to cover as wide a range of branches as possible, the efficiency of fetching of branch targets way before the branch itself achieves a higher level of precision. This increased level of precision eliminates pipeline stalls between branches and targets where prior concerns of creating data integrity within the pipeline of a microprocessor existed.

### FIELD OF THE INVENTION

This invention relates to computer processing systems, and particularly to branch detection in relationship to target prediction and instruction fetching in a computer processing system.

### BACKGROUND

A microprocessor having a basic pipeline microarchitecture processes one instruction at a time. The basic dataflow for an instruction follows the steps of: instruction fetch, decode, address generation, cache access, register read, execute, and write back. Each stage within a pipeline or pipe occurs in order and hence a given stage can not progress unless the stage in front of it is progressing. In order to achieve highest performance one instruction will enter the pipeline every cycle. Whenever the pipeline has to be delayed or cleared, this adds latency which in turn negatively impacts the performance with which a microprocessor carries out a task. While there are many complexities that can be added on, the above summary sets the groundwork for branch prediction theory.

There are many dependencies between instructions which prevent the optimal case of a new instruction entering the pipe every cycle. These dependencies add latency to the pipe. One category of latency contribution deals with branches. When a branch is decoded, it can either be taken or not taken. A branch is an instruction which can either fall through to the next sequential instruction, i.e., not taken, or branch off to another instruction address, i.e., taken, and carry our execution of a different series of code.

“Resolution” is the determination of the direction that a branch takes. At decode time, the branch is detected, and must wait to be resolved in order to know the proper direction that the instruction stream is to proceed. Waiting for potentially multiple pipeline stages for the branch to resolve the direction to proceed adds latency to the pipeline.

To overcome the latency of waiting for the branch to resolve, the direction of the branch can be predicted such that the pipe begins decoding either down the taken or not taken path. At branch resolution time, the guessed direction is compared to the actual direction the branch was to take. If the actual direction and the guessed direction are the same, then the latency of waiting for the branch to resolve has been removed from the pipeline in this scenario. If the actual and predicted direction miscompare, then decoding proceeded down the improper path and all instructions in this path, behind those of the improperly guessed direction of the branch, must be flushed out of the pipe, and the pipe must be restarted at the correct instruction address to begin decoding the actual path of the given branch. Because of controls involved with flushing the pipe and beginning over, there is a penalty associated with the improper guess and latency is added into the pipe over simply waiting for the branch to resolve before decoding further.

By having a proportionally higher rate of correctly guessed paths, the ability to remove latency from the pipe by guessing the correct direction out weighs the latency added to the pipe for guessing the direction incorrectly.

In order to improve the accuracy of the prediction associated with the direction of a branch, a branch history table (BHT) can be implemented. The BHT facilitates direction prediction of a branch based on the past behavior of the direction the branch previously went. If the branch is always taken, as is the case of a subroutine return, then the branch will always be guessed as taken. IF/THEN/ELSE structures become more complex in their behavior. A branch may be always taken, sometimes taken and sometimes not taken, or always not taken. Based on the implementation of a dynamic branch predictor, this will determine how well the BHT predicts the direction of the branch.

When a branch is guessed taken, the target of the branch is to be decoded. The target of the branch is acquired by making a fetch request to the instruction cache for the address which is the target of the given branch. Making the fetch request out to the cache involves minimal latency if the target address is found in the first level of cache. If there is not a hit in the first level of cache, then the fetch continues through the memory and storage hierarchy of the machine until the instruction text for the target of the branch is acquired. Therefore, any given taken branch detected at decode has a minimal latency associated with it that is added to the amount of time it takes the pipeline to process the given instruction. Upon missing a fetch request in the first level of memory hierarchy, the latency penalty the pipeline pays grows higher and higher the further up the hierarchy the fetch request must progress until a hit occurs. In order to hide part or all of the latency associated with the fetching of a branch target, a branch prediction array, such as a branch target buffer (BTB), can work in parallel with a BHT.

Given a current address which is currently being decoded from, the BTB can search for the next instruction address from this point forward which contains a branch. Along with storing the instruction address of branches in the BTB, the target of the branch is also stored with each entry. With the target being stored, the address of the target can be fetched before the branch is ever decoded. By fetching the target address ahead of decode, latencies associated with cache misses can be minimized in respect to the time it takes between the decode of the branch and the decode of the target.

In a CISC based machine, there can be millicode which handles complex routines of varying length. Based on the operations millicode is performing, it maintains the authority to update the state of the machine for required reasons. Such reasons could be controlled from the operating system where a task swap is to take place such that a different program acquires microprocessor resources to execute its task. Other reasons for such controlling could be on the level of machine virtualization where the machine is made to look like multiple machines (virtual machines) and the control code is altering machine state such that processing resources can be given to different virtual machines at different time frames. These millicode routines are entered via a branch point, and are likewise exited from via another branch point, millicode end (MCEND). The ability to predict the return branch (MCEND) of such a routine prevents unnecessary pipeline stalls and hence improves performance.

Millicode's ability to operate on the state of the machine is to the extent that it can change many aspects of the machine that a non-supervisor state user code is not privileged to act on. Some of these areas include control registers and the program instruction address, where the machine is currently within a program it is running. Upon changing a control register, the state of the machine has been modified, and the operation of the pipeline may behave differently after the end of the millicode routine in regard to its operation prior to the entry of millicode. In such circumstances, if the MCEND is predicted by the BHT/BTB, then the central processor pipeline can start to act on instruction addresses and/or instruction text following this point potentially as though the state of the machine is that of what it was prior to millicode entry and not that of how millicode updated the state of the central processor.

By allowing a bit within the instruction text to state if a particular instance of a branch is to be written into the BTB, two results are achieved: 1) branches which are performance critical and do not return from state altering routines can be added into the BTB for branch prediction. 2) Branches which exit a routine which altered the state of a machine can be blocked from being written into the BTB such that they are never predicted. This invention allows for higher processor performance via branch prediction while maintaining data integrity and preventing a measurable growth in silicon area or power.

One problem heretofore encountered with the use of a branch history table (BHT) and a branch target buffer (BTB) in respect to predicting branches which exit machine state routines on a CISC microprocessor was the problem that such predictions can potentially corrupt the state of a machine thereby resulting in loss of data integrity. Thus, a clear need exists to allow such predictions where the exiting of a CISC based routine can be guaranteed to not have altered the integrity of the processed data outcomes based on system state.

### SUMMARY OF THE INVENTION

The shortcomings of the prior art are overcome and additional advantages are provided through the provision of a mechanism that prohibits certain branches to be predicted in an asynchronous time frame in respect to the decoding of the said instruction. In particular, this modification is a descriptor bit in the opcode of a branch that states if the branch is allowed to be predicted or not.

As noted above, the use of a branch history table (BHT) and a branch target buffer (BTB) to predict branches which exit machine state routines on a CISC microprocessor have been prohibited because such predictions can potentially corrupt the state of a machine thereby resulting comprising data integrity. The method, system, and program product described herein solves this short coming by allowing such predictions when the exiting a CISC based routine while avoiding data altering outcomes based on system state.

The method, system, and program product described herein prevent asynchronous out of order progression of certain stages of a microprocessor pipeline such as instruction fetching. Through the blocking techniques described herein, fetching can be blocked when the fetch that was initialized via the prediction of a branch target from a branch target buffer is known to decode improperly because of a machine state alteration event. Likewise, fetching can be blocked when it is known that the target or direction of the stated branch has very low accuracy, such that the amount of penalties encountered for wrong target and direction predictions out weigh the advantage of predicting correctly in those cases where the target and direction would be predictable.

This is accomplished through a computer system, a method of operating a computer having a pipelined processor, and a computer program product for branch prediction in a pipelined CISC. This is implemented by defining a bit within an instruction text field of a branch whereby to prevent the branch from being placed into a branch target buffer and to thereby make the branch only detectable as the time frame of decode. This results in predicting the direction and target of a branch prior to decode, frequently using a branch prediction array (as a branch target buffer). The branch is tracked from the beginning of the pipe, decode, until the time frame that the given instruction is to be written into a branch prediction array. In carrying out the invention, the instruction text field may be denoted as a non-writable branch into the BTB. More particularly, the instruction field in the system area is denoted as a non-writable branch into the BTB in system so that the branch is blocked. The instruction field when denoted in the non-system area may encounter aliasing. As a general rule machine state altering code lies within an address range supported by branch tag bits of the branch target buffer. According to the invention branches which have targets that are highly non-constant can be blocked from branch predictions through the use the BTB blocking field in the instruction text. Also, state altering code in the system area can be denoted by a state bit within the BTB/BHT such that aliasing of branches within system area is prevented.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### THE FIGURES

Various aspects of our invention are illustrated in the accompanying drawings in which:

FIG. 1 illustrates one example of a typical basic processor pipeline

FIG. 2 illustrates one example of a typical BTB/BHT structure

FIG. 3 illustrates one example of front end pipe timing relative to register write back timing

FIG. 4 illustrates one example of a decision table for writing MCENDs into the BHT/BTB

### DETAILED DESCRIPTION OF THE INVENTION

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying figures.

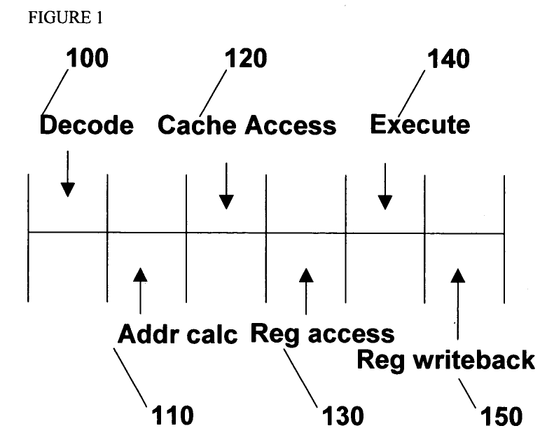

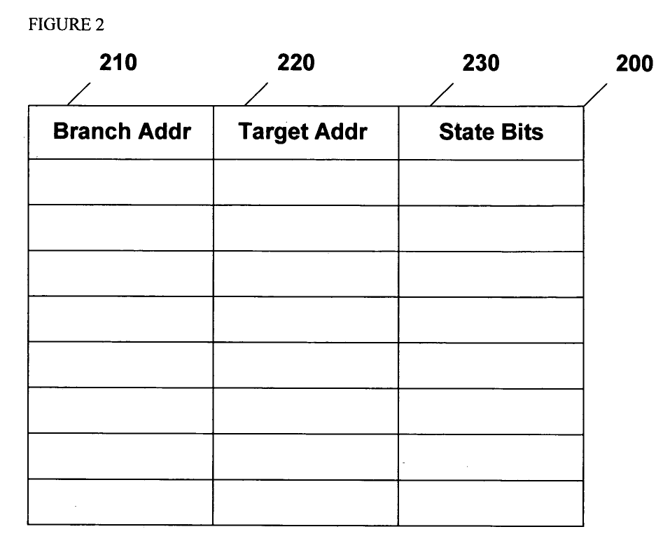

The present invention is directed to a method and apparatus for branch prediction and branching in regard to selectively starting at decode 100, shown generally in FIG. 1, where branches are to be classified as those branches which are predictable by the BHT/BTB 200, shown generally in FIG. 2, and those branches which are not allowed to be predicted by the BHT/BTB 200. This method allows taking a set of branches which were previously not allowed to be predicted via the BTB/BHB, MCEND per example. The previous prohibition of the prior art was because certain instances of predicting MCEND could lead to data integrity.

A basic pipeline can be described in 6 stages. The first stage involves decoding 100 an instruction. During the decode time frame 100, the instruction is interpreted and the pipeline is prepared such that the operation of the given instruction can be carried out in future cycles. The second stage of the pipeline calculates the address 110 for any decoded 100 instruction which needs to access the data or instruction cache. Upon calculating 110 any address required to access the cache, the cache is accessed 120 in the third cycle. During the fourth cycle, 130, it is determined if the requested data was in the cache and if so, the data is transferred over to the execution unit. Furthermore, any registers needed for performing the logistics of an instruction is acquired at this time frame 130. Upon gathering the information, the instruction can be executed 140 during the fifth cycle. The results are then written back 150 during the sixth cycle.

As illustrated in FIG. 2, with respect to asynchronous pipelining of instruction text, the branch prediction logic 200 is off searching for the next branch that it predicts the decode stage will encounter. This searching takes place by sequentially searching the BTB 200 for a branch address that occurs sequentially after the point of where decode currently is. Along with each branch address 210 is a target address 220 for the given branch based on the target of the last occurrence of the stated branch. The third part of information stored is in regard to the BHT; the state bits, 230, predict if the branch should be guessed taken or not taken. The state bits include any extra state bits that are required for a given branch 230. When a taken branch is located, a fetch request is initiated for the target and the information is passed along to decode 100. When decode 100 references the predicted branch, decode 100 can block the target fetch 120 of the branch as the BTB 210, 220 caused the target to be kicked off at an early time frame. Because the fetch was kicked off earlier, the target can ideally decode the cycle after the branch without occurring any pipeline delay.

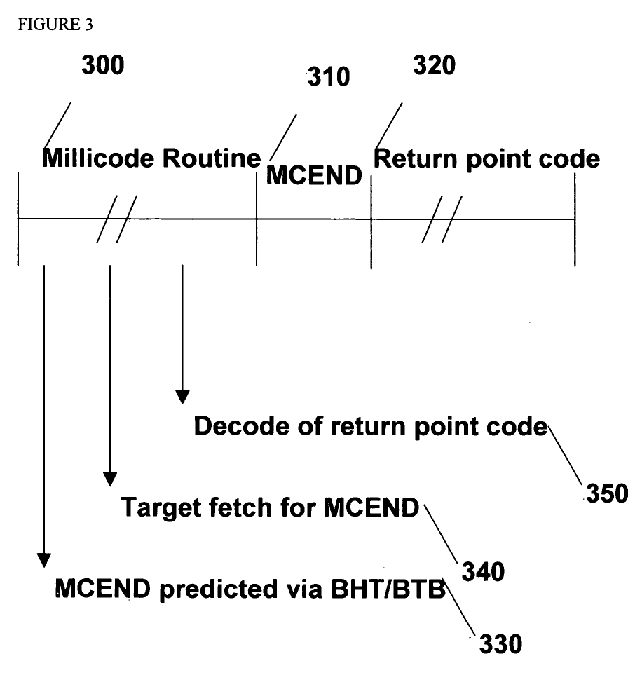

The MCEND instruction is a branch that returns from a millicode routine. As shown in FIG. 3, the BTB can be asynchronously searching for the next branch, potentially the MCEND while the execution portion of the pipeline is working on a much earlier portion of the millicode routine 300. During the execution of the millicode routine 300, the BTB can find a MCEND branch 330 that is predicted to occur in the future, and cause a fetch 340 to go out for the target of the MCEND. Because decode occurs in the pipeline stage before that of the execute stage, decode can then be decoding the return point code 350 of the MCEND and its target 320 prior to the execution stage finishing up the millicode routine 310. The millicode routine may be updating the state control register within the machine that will alter the fetching behavior of the machine or alter the operation of instructions that occur upon the exiting of millicode. Because branch prediction has allowed the prediction of the MCEND, the machine will take the form of a corrupted state if something is not done to prevent the prediction of the MCEND. It is possible to simply not place any MCEND instruction in the BTB/BHT and therefore never allow it to be predicted; however, this hinders performance in the numerous cases where predicting the MCEND can not lead to data integrity but can yield higher performance.

The ability to prevent a branch from being predicted via a bit within its instruction text, MCEND in the example of this specific description, is attained by preventing the branch in the first place from being written into the branch history table (BHT) and branch target buffer (BTB) 200. In the designing of millicode, a coder determines what MCENDs should be predictable and which one should not be predictable. It is taken that all MCENDs should be predictable unless a given MCEND is coming from a routine which changes the state of the processor, in which case, the code designer will set a bit, ‘X’, in the MCEND instruction text which states that the given branch is not suited for branch prediction.

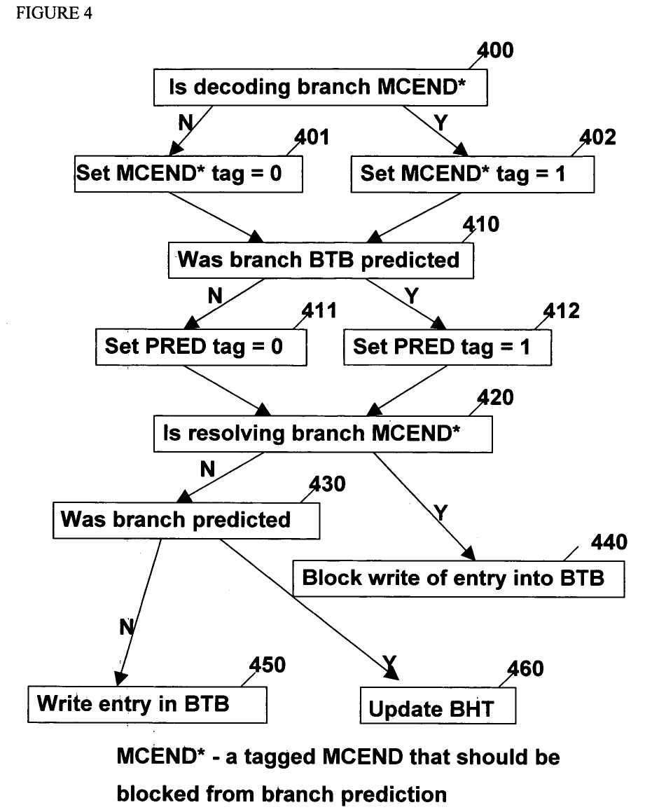

This is illustrated in FIG. 4. Upon decoding 400 of the MCEND 401, 402, branch for the first time in the “Was Branch BTB Predicted” test, 410, it is placed in a branch queue that keeps track of branches from decode to branch resolution in a manner that all branches are tracked throughout the pipeline. When a branch is decoded for the first time, “Set PRED Tag=0” 411, it can not be a predicted branch as a branch must have been reached in a prior time frame such that it can be predicted in the present/future time frame. Furthermore, like any other instruction, the required instruction text is kept track of from decode until the execution time frame. In keeping track of the branch, the status of the branch being predicted, “Set PRED Tag=1” 412 or encountered for the first time, “Set PRED Tag=0” 411 is remembered. At the time frame of branch resolution, it is determined if a branch is to be written into the branch history table and branch target buffer. In determining if the branch is to be written into the branch prediction tables/arrays, it is to be determined if the branch needs to be blocked from being written for any reason. In the case of this description, coder tagged MCENDs, “Is resolving MCEND” 420 are of concern. If the branch is not a tagged MCEND 430 then if the entry is currently not in the BTB, it needs to be written in 450. Likewise, if it is already in the table, then the history table gets updated 460 based on the directional resolution of the branch. If the branch is a tagged MCEND 440, it is currently not in the BTB and should additional be blocked from being written in such that it will not be predicted on the following occurrence.

Because the BTB may not cover the full memory address range of the machine, it is possible for address aliasing to occur. In order to prevent harmful effects of branch address aliasing, two items must be stored within the BTB such that harmful results of branch aliasing are prevented. The first item is that of the partial branch address which is already stored in the BTB to perform a tag 210 match to suggest that a predicted branch match has been located. Secondly, a tag is placed in with each branch entry to determine if the branch of interest is in system area. Only system area instruction can alter the state of the machine. By forcing system area to fall within one segment of the branch address tag bits, this prevents aliasing of system area branches, thereby guaranteeing that an MCEND predicted in the BTB is the MCEND of interest, and not that of some aliased MCEND. In the case where performance is of concern and data integrity is not at risk through branch prediction, then the verification of system area or the like is not required. Such scenarios are the case when there is a bit defined in a generic branch that is used to prevent prediction of the given branch in regard to aiding the accuracy of a highly fluctuating branch target.

Within the context of denoting the instruction field in the non-system area, the branch may be predicted for aliasing, By “may be predicted for aliasing” we illustrate by assuming 64 bits of addressing; therefore a branch could occur at any address that is addressable via the 64 bits. To create a [silicon based] table that is 2\hat{ }64 (2 to the 64^{th} power) in size is implausible in today's technology A practical hardware limit is on the order of about 2\hat{ }10 (2 to the 10^{th} power) to 2\hat{ }16 (2 to the 16^{th} power) given today's technology given that it is desired to access the table with very low latency. If the table is addressed with 10 bits then you can place 54 (64 minus 10) tag bits with each entry to determine if the value you lookup is for the complete address you want. This is done by performing a compare between the i.e. 54 tag bits and the equivalent 54 address bits that were not used to address the table. When it comes to a BTB which deals with performance, it is not required to keep around all 54 tag bits as the performance gain for acquiring the additional precision of, for example, comparing 54 bits versus 20 bits is so minimal that the area on the chip can be used for better purposes. Therefore a branch located at address X in one (2\hat{ }(64−(20+10))) range will match with a branch at address Y in a different (2\hat{ }(64−(20+10))) range given that the lower 30 bits of the address are the same. If you are searching for branch X and find branch X, the desired outcome is achieved. If you are searching for branch X and get a match on branch Y, then the wrong branch was detected and this match is an alias match. Hence for any entry where a subset of the address bits available for tag bits are used, aliasing is possible; hence, a branch prediction “may be” predicted as an aliased branch.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method operating a computer having a pipelined processor, comprising defining a bit within an instruction text field of a branch whereby to prevent the branch from being placed into a branch target buffer to thereby make the branch only detectable as the time frame of decode.

2. A method as defined in claim 1 comprising predicting the direction and target of a branch prior to decode.

3. A method as defined in claim 2 comprising predicting the direction and target of a branch prior to decode through a branch prediction array.

4. A method as defined in claim 1 comprising tracking the branch from the beginning of the pipe, decode, until the time frame that the given instruction is to be written into a branch prediction array.

5. A method as defined in claim 1 comprising denoting the instruction text field as a non-writable branch into the BTB.

6. A method as defined in claim 5 denoting the instruction field in the system area as a non-writable branch into the BTB in system whereby the branch is blocked.

7. A method as defined in claim 5 denoting the instruction field in the non-system area, the branch may be predicted via aliasing.

8. A method as defined in claim 1 wherein machine state altering code lies within an address range spanned by branch tag bits of the branch target buffer.

9. A method defined in claim 4 where branches which have targets that are highly non-constant can be blocked from branch predictions through the use the BTB blocking field in the instruction text.

10. The method as defined in claim 8 comprising denoting state altering code in the system area by a state bit within the BTB/BHT such that aliasing of branches is prevented within the system area.

11. A computer system having input, output, storage, and a pipelined processor, said processor adapted and configured to define a bit within an instruction text field of a branch whereby to prevent the branch from being placed into a branch target buffer to thereby make the branch only detectable as the time frame of decode.

12. A computer system as defined in claim 11, said computer system adapted and configured to predict the direction and target of a branch prior to decode.

13. A computer system as defined in claim 12 said computer system adapted and configured to predict the direction and target of a branch prior to decode through a branch prediction array.

14. A computer system as defined in claim 11, said computer system adapted and configured to track the branch from the beginning of the pipe, decode, until the time frame that the given instruction is to be written into a branch prediction array.

15. A computer system as defined in claim 11 said computer system adapted and configured to denote the instruction text field as a non-writable branch into the BTB.

16. A computer system as defined in claim 15 said computer system adapted and configured to denote the instruction field in the system area as a non-writable branch into the BTB in system whereby the branch is blocked.

17. A computer system as defined in claim 15 said computer system adapted and configured to denote the instruction field in the non-system area, the branch may be predicted via aliasing.

18. A computer system as defined in claim 11 wherein machine state altering code lies within an address range spanned by branch tag bits of the branch target buffer.

19. A computer system as defined in claim 14 where branches which have targets that are highly non-constant can be blocked from branch predictions through the use the BTB blocking field in the instruction text.

20. A computer system as defined in claim 18 said computer system is adapted and configured to denote state altering code in the system area by a state bit within the BTB/BHT such that aliasing of branches is prevented within the system area is prevented.

21. A program product comprising a storage medium having computer readable program code, said program code for use in a computer system having input, output, storage, and a pipelined processor, said program code adapting and configuring the computer system to define a bit within an instruction text field of a branch whereby to prevent the branch from being placed into a branch target buffer to thereby make the branch only detectable as the time frame of decode.

22. A program product as defined in claim 21, said computer system adapted and configured to predict the direction and target of a branch prior to decode.

23. A program product as defined in claim 22 said computer system adapted and configured to predict the direction and target of a branch prior to decode through a branch prediction array.

24. A program product as defined in claim 21, said computer system adapted and configured to track the branch from the beginning of the pipe, decode, until the time frame that the given instruction is to be written into a branch prediction array.

25. A program product as defined in claim 21 said computer system adapted and configured to denote the instruction text field as a non-writable branch into the BTB.

26. A program product as defined in claim 25 said computer system adapted and configured to denote the instruction field in the system area as a non-writable branch into the BTB in system whereby the branch is blocked.

27. A program product as defined in claim 25 said computer system adapted and configured to denote the instruction field in the non-system area, the branch may be predicted via aliasing.

28. A program product as defined in claim 21 wherein machine state altering code lies within an address range spanned by branch tag bits of the branch target buffer.

29. A program product as defined in claim 24 where branches which have targets that are highly non-constant can be blocked from branch predictions through the use the BTB blocking field in the instruction text.

30. A program product as defined in claim 28 said computer system is adapted and configured to denote state altering code in the system area by a state bit within the BTB/BHT such that aliasing of branches is prevented within the system area.
